(19) United States
(12) Patent Application Publication
(10) Pub. No.: US 2019/0185138 A1
(43) Pub. Date: Jun. 20, 2019

(54) Cruise miniflaps for aircraft wing

(71) Applicant: Eesti Lennuakadeemia, Reola Village (EE)

(72) Inventor: Peep LAUK, Reola village (EE)

(73) Assignee: Eesti Lennuakadeemia, Reola Village (EE)

(21) Appl. No.: 16/220,337

(22) Filed: Dec. 14, 2018

(30) Foreign Application Priority Data
Dec. 14, 2017 (EP) 17207454

(51) Int. Cl. B64C 9/18; B64C 9/34; B64C 13/34

(52) U.S. Cl. CPC B64C 9/18; B64C 3/185; B64C 13/34; B64C 9/34

(57) ABSTRACT

This disclosure provides construction variants of a cruise miniflap of an aircraft wing that is added to trailing edge flap of an aircraft wing and can be used for improving the aerodynamic properties of an aircraft. In the rear edge of the cruise miniflap there is a cavity with a height of up to 1% of the wing chord.

### PRIORITY

This application claims priority of European patent application number EP 17207454.4 filed on 14 Dec. 2017, the contents of which is incorporated herein by reference.

### FIELD OF THE INVENTION

This invention relates to increasing the aircraft wing lift and to decreasing the aerodynamic drag during flight. The cruise miniflap (hereinafter CMF) according to the invention is part of the aircraft wing or the trailing edge flap and it can be used to modify the camber and the area of the aircraft wing and to create a cavity within the wing trailing edge.

### BACKGROUND

The high wing loading of modern long range commercial airplanes does not allow them to achieve the optimal cruise altitude after take-off without a sharp increase of the aerodynamic drag because the used wing profile has been designed for low aerodynamic drag, with the lift coefficient C_{L} within the range of 0.45-0.6. Lower cruise altitude, however, results in a slower air speed relative to the land surface, which in turn increases fuel consumption. In the areas of heavy air traffic, lower cruise altitude often prevents from selecting the direct route to the destination airport. Therefore, heavier aircraft have high fuel consumption in the first stage of the flight. The invention described herein provides means for increasing the wing lift coefficient to the level of 0.7-0.8 so that the drag coefficient does not grow substantially. It allows the commercial transport airliners to reach higher altitudes after take-off and to improve the aerodynamic value (lift to drag or L/D ratio), which substantially reduces fuel consumption and also lengthens the flight distance.

Various modified aircraft wing trailing edges have previously been patented. The most relevant of these are the following:

Document GB 2174341A, 5 Nov. 1986, The Secretary of State for Defence (United Kingdom) (1), describes a supercritical wing section provided with a hinged flap attached to the wing.

Document US6565045 B1, 20 May 2003, Onera, describes an aerodynamic surface, such as a wing, comprising a reduced-pressure face and a pressure face which are connected at the front section of the wing.

In document US 2007/0221789 A1, 27 Sep. 2007, Hak-Tae Lee et al. describe an improved trailing edge aerodynamic control effector.

In document US 2013/0214092 A1, 22 Aug. 2013, Airbus Operations GmbH, an aerodynamic wing section with ancillary flaps has been described which can be moved with a guide mechanism and a drive device for actuating the ancillary flaps.

Document GB 2174341A describes a device arranged to the trailing edge of a supercritical wing profile, which can be used to modify the camber as well as the thickness of the wing trailing edge.

Compared to the above solutions, the device according to this invention ensures lower aerodynamic drag because a supercritical wing profile with a cavity in the trailing edge has lower aerodynamic drag than a blunt trailing edge, and in addition, the device provided in this invention alters the area of the wing, which also makes it possible to reduce the aerodynamic drag.

Differently from the devices known in the prior art, such as the devices described in documents U.S. Pat. No. 6,565,045 B1 and US 20070221789 A1, the device according to this invention, when in retracted state, provides a thinner trailing edge and consequently, also a substantially lower C_{L} value (0.4-0.6). The above-said implication can be illustrated by the graph from U.S. Pat. No. 6,565,045 B1 which reveals that the aerodynamic surface developed by the applicants reduces drag when C_{L}>0.7. With the device according to this invention, the value of C_{L}>0.63 is achieved. The graph cited above also shows that the drag coefficient C_{d} is substantially higher than the value achieved with the device provided in this invention. US 2007/0221789 anticipates the simultaneous use of several effectors because the width of the element is relatively small. The device according to this invention has a simpler construction, it is more rigid and, all in all, more reliable. With C_{L} in the range of 0.4-0.75, the device provided in this invention also has lower aerodynamic drag at Mach 0.75-0.8. When compared with the device described in US 2013/0214092, the cruise miniflap according to this invention (CMF) has lower aerodynamic drag, it is more rigid and becomes less deformed under the air flow, therefore, it provides for a more reliable way to improve the performance of aircraft.

### SUMMARY OF THE INVENTION

The cruise miniflap (CMF) according to this invention is an ancillary aerodynamic surface which can be provided at the trailing edge, in the trailing edge flap or the ailerons. If necessary, the cruise miniflap can be moved mechanically by means of actuators and this way it is possible to modify the camber, area and shape of the trailing edge. The transition between the wing and the CMF is relatively smooth and there are no sharp transitions characteristic to conventional trailing edge flaps. One wing can be provided with one or more cruise miniflap sections. With the use of more than one cruise miniflap it is possible to optimise the distribution of lift across the span of the wing and additionally reduce induced drag. The trailing edge with a cavity permits to reduce drag (C_{L}>0.6) and at Mach>0.65. The optimal height of the trailing edge depends on the used wing profile, the lift coefficient and the object's air speed. For example, when the Mach number of the supercritical wing profile at the cruise speed is 0.78 and the lift coefficient C_{L} is 0.7, the optimal height of the trailing edge with a cavity is 0.7% of the chord length. In the case of the higher lift coefficient value, the optimal height of the trailing edge with a cavity is also higher. If the value of C_{L} is less than 0.6, the trailing edge with a cavity does not reduce drag and it is in the retracted state. The trailing edge with a cavity may be fixed or with a modifiable height and shape. The profile of the cavity may be arched or angular. To modify the height, the upper or lower edge of the CMF may be used.

The use of the CMF makes it possible to reduce the cost of maintenance and repair of the engines because the power required during the flight is reduced and therefore the engines do not wear so much. In addition to lower fuel consumption, the invention helps to reduce emission of pollutants and noise.

### SHORT DESCRIPTION OF DRAWINGS

In order to give a better and more detailed overview of the invention, the following embodiments with reference to the drawings will be described, of which:

FIG. 1 depicts the position of the CMF according to the invention within the wing (trailing edge flap) and its basic states, from which the one used in the initial stage of take-off and cruise is depicted in at the bottom of the figure (c), the state employed during the flight when the amount of fuel and the in-flight weight are decreasing is in the middle (b), and the state used in the final stage is at the top of the figure (a);

FIG. 2 depicts the lift coefficient and drag coefficient ratio of the wing profile for a commercial transport aircraft at the speed corresponding to Mach 0.78. As seen in the figure, aerodynamic drag starts to grow rapidly at the C_{L} value of 0.63. With the use of the cruise miniflap of the invention, however, it is possible to reduce the aerodynamic drag substantially at the level of C_{L}>0.62. When the in-flight weight decreases (because the fuel is being consumed), it is beneficial to retract the CMF gradually during the flight because the aerodynamic drag is smaller if the value of C_{L} is within the range 0.4-0.6;

FIG. 3 depicts the effect of various shapes of the wing trailing edge on the drag coefficient at the C_{L} value of 0.7 at different cruise speeds and the graph in the figure shows that the lowest drag at M 0.78 is achieved when the height of the cavity in the trailing edge is 0.7%;

FIG. 4A is a graph showing the distribution of the lift (load) over the length of the wing. Distribution of lift over the wing length usually differs from the ideal (elliptic) due to engineering reasons. By using different positions of the cruise miniflap (CMF) sections, distribution of lift can be approximated to the elliptical, which in turn reduces the induced drag. The cruise miniflap (CMF) may partially also be located within the ailerons.

FIG. 4B depicts a wing with various CMF sections in different positions. It gives the possibility to control the distribution of the lift over the span of the wing as necessary. The greatest increase in lift is achieved when the cruise miniflaps (CMFs) are used with the increasing of the deflection angle of ailerons and with the winglets at the wing tip;

FIG. 5 depicts possible variants of the cruise miniflap (CMF); FIG. 5A shows a fixed-height miniflap (CMF) profile, the shape of which, when retracted, is modified by the upper and lower edge of the trailing edge flap; the miniflap in FIG. 5B has an upper panel 42 with a changeable angle and height, whereas the cavity is almost non-existent when the miniflap is retracted; FIG. 5C shows a cruise miniflap with a rectangular cavity and an upper controllable panel; FIG. 5D shows a cruise miniflap with a rectangular cavity and a lower controllable panel; FIG. 5E shows a cruise miniflap with a lower edge which is curved downward and a trailing edge cavity of a fixed height, whereas the shape of the profile, when retracted, is modified by the upper and lower edge of the trailing flap;

FIG. 6 depicts a cross-sectional view of the rear part of the trailing edge flap; FIG. 6A shows the cruise miniflap in its completely retracted state and FIG. 6B the cruise miniflap in the completely extended state. FIG. 6C shows the actuating mechanism for moving the deflectable under panel;

FIGS. 7A and 7B depict a mechanism for moving the cruise miniflap which is located partially outside the trailing edge flap within the wing fairing.

### DETAILED DESCRIPTION OF THE INVENTION

The invention is described here with reference to the figures.

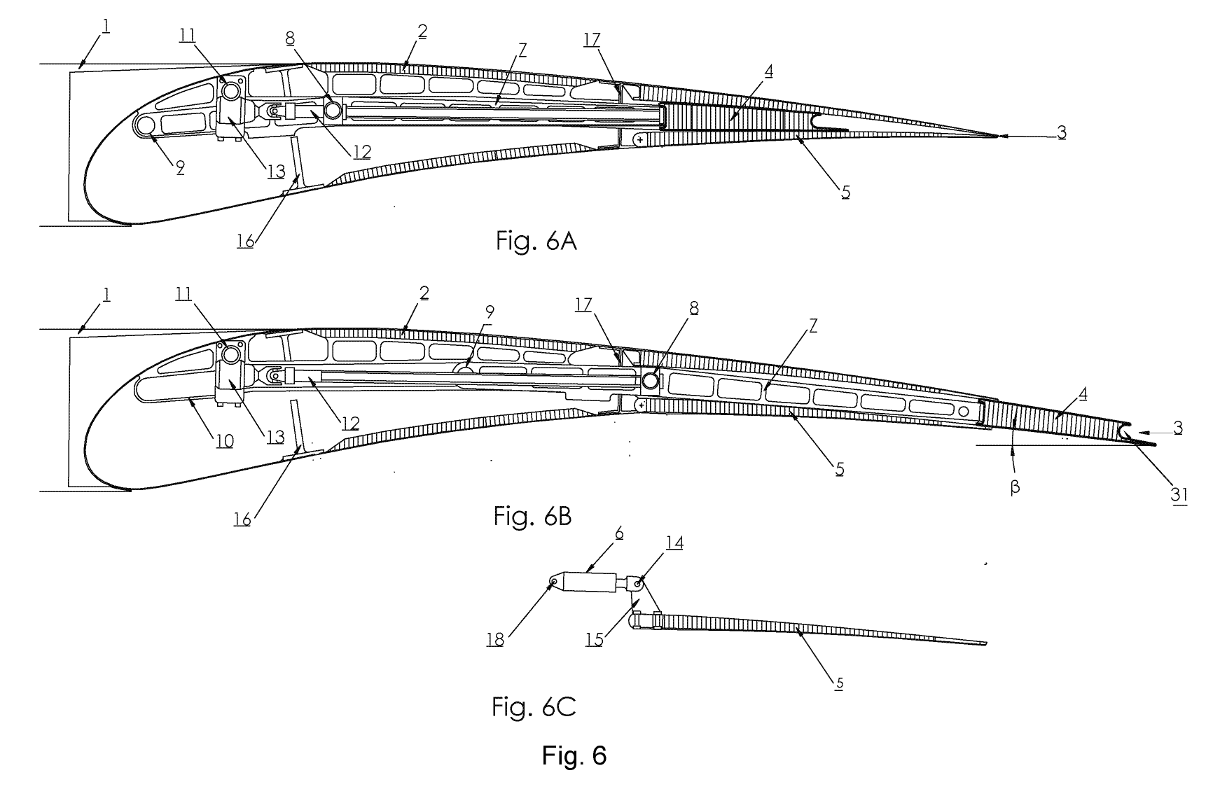

FIG. 6 illustrates a cross-sectional view of the trailing edge flap in which the cruise miniflap is used. FIG. 6A depicts a cruise miniflap (CMF) in its completely retracted state. FIG. 6B depicts a cruise miniflap in its completely extended state. FIG. 6C depicts the mechanism for moving the deflectable under panel 5 where the horn 15 of the deflectable under panel is coupled, through the rear pivotal articulation 14, with the actuator 6, which through the forward pivotal articulation 18 is connected to the main construction of the trailing edge flap.

The cruise miniflap 4 is located in the rear part of the wing 1 or the trailing edge flap 2. In FIG. 6A, the cruise miniflap 4 is in the retracted state. The miniflap is attached to the rear end of the control unit 7, also the rear roller 8 and the first roller 9 are attached to the control unit 7, which move along the guideway 10 fastened to the main construction of the trailing flap. The load occurring due to the pressure difference is distributed from the trailing flap surface between the first spar 16 and the rear spar 17. To the main construction of the trailing edge flap or the guideway 10, an electrical motor 11 is fixed that rotates, through the reduction gear 13, the screw mechanism 12 with its end fixed to the rear roller 8 in a way that the nut attached to the roller 8 moves in a linear manner along the screw of the screw mechanism 12 and together with this, the control unit 7 with the cruise miniflap moves until it is in the entirely extended state, as shown in FIG. 6B. At the same time, the rear roller 8 and the first roller 9 are moving along the guideway 10. The function of the rollers is to stabilize the movement of the control unit along the guideway. The guideway 10 is fixed to the first spar 16 and the rear spar 17 of the wing (trailing flap). When the cruise miniflap moves to the extended state, it also slopes downward by the extension angle β (see FIG. 6B, the angle β is between the horizontal plane and the lower plane of the cruise miniflap). With the movement of the cruise miniflap, the under panel 5 of the wing (trailing edge flap) is sloped by means of the actuator 6. Through the forward pivotal articulation 18, the actuator 6 is fixed to the main construction of the wing (trailing edge flap) and by means of the rear pivotal articulation 14, it is fixed to the actuating horn 15 which moves the under panel 5. When the cruise miniflap (CMF) is being retracted, all parts move along the same trajectory, but in the opposite direction until the miniflap is in the retracted state.

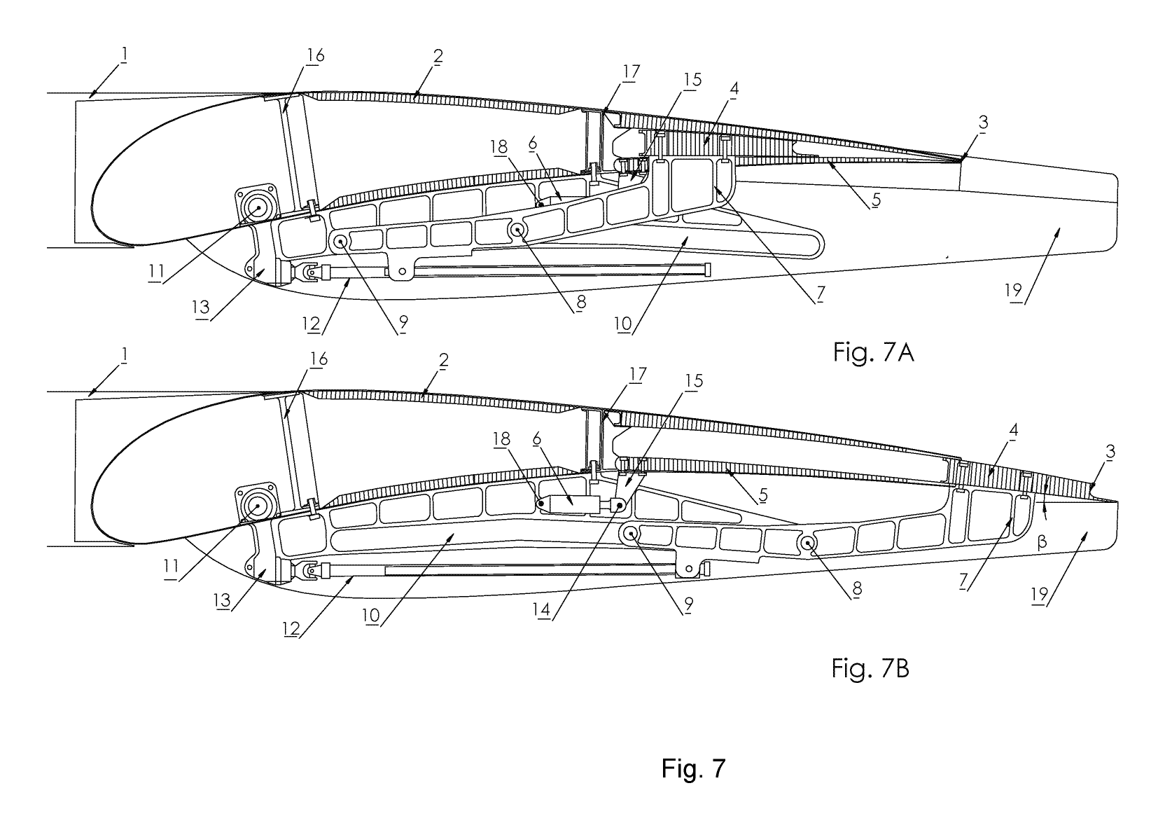

In an alternative embodiment, especially in the case of the trailing edge flaps of a large aircraft, the mechanism for moving cruise miniflaps (drive (electrical motor) 11, reduction gear 13, screw mechanism 12 with the screw pair comprising of a threaded rod and a threaded nut moving along it) with the control unit 7, guideway 10, first and rear roller and the mechanism for moving the under panel of the trailing flap may be located within the wing fairing 19 (see FIG. 7B). In this case, the screw of the screw mechanism may be fixed to the horn, provided for this purpose in the control unit, which is not coupled with the rear roller.

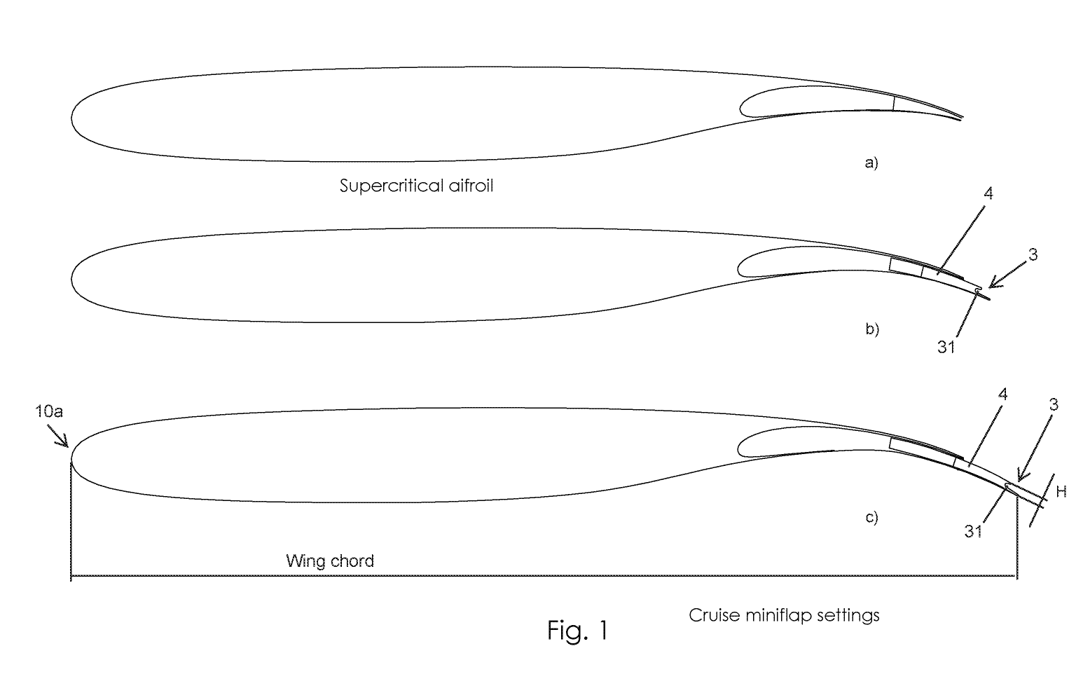

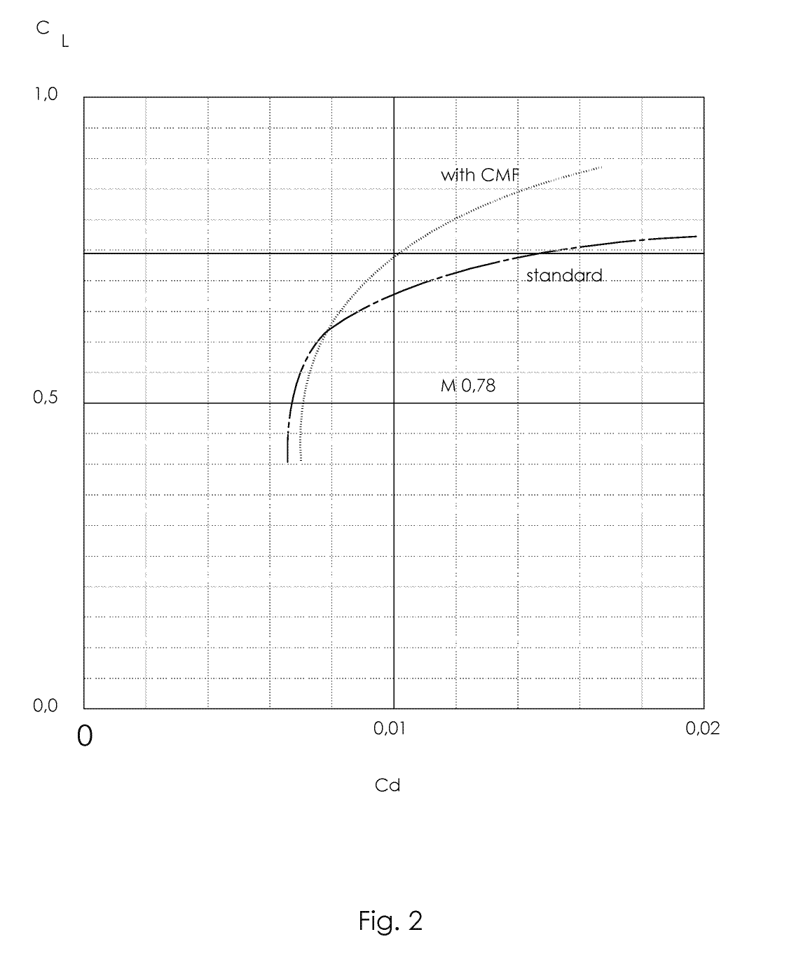

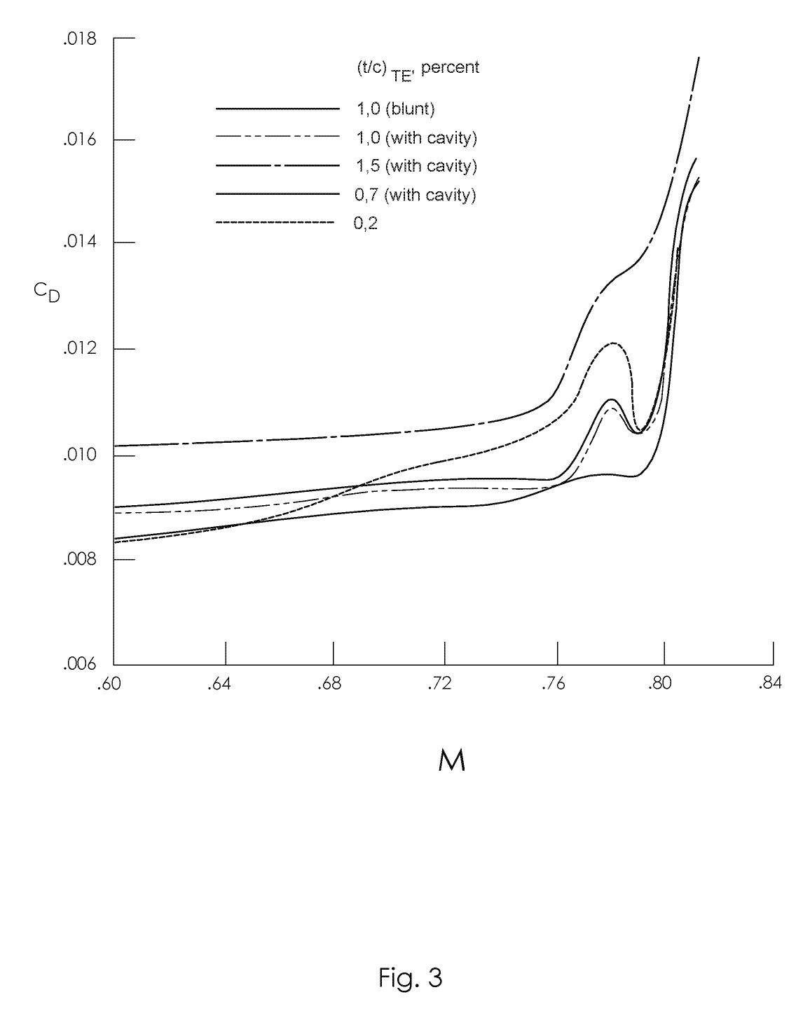

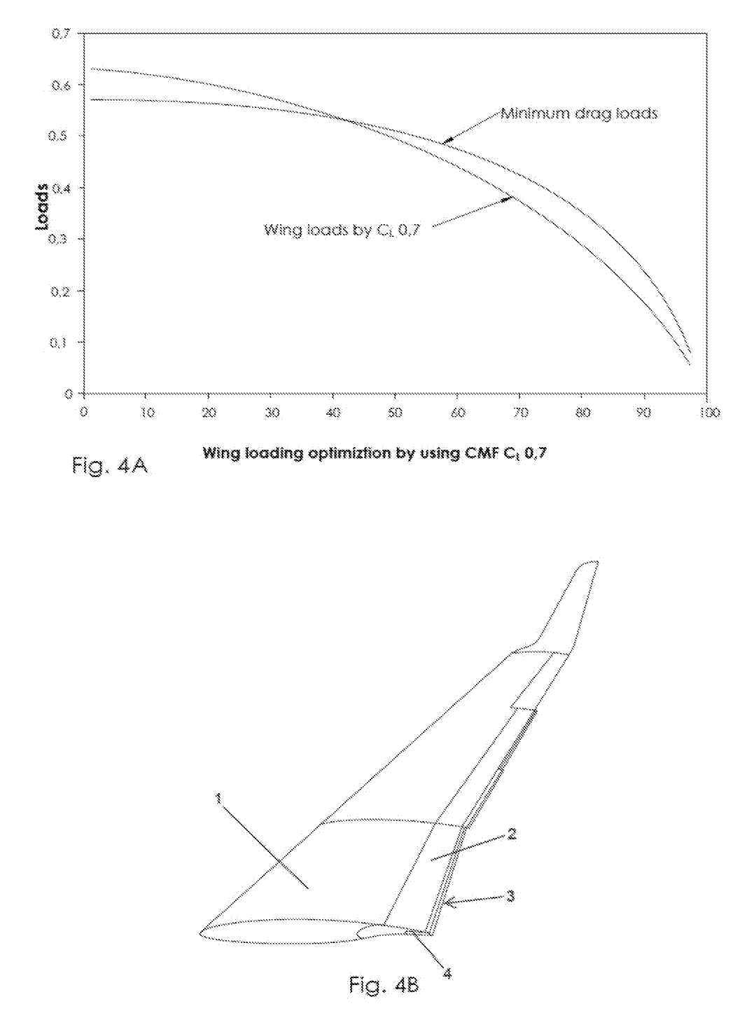

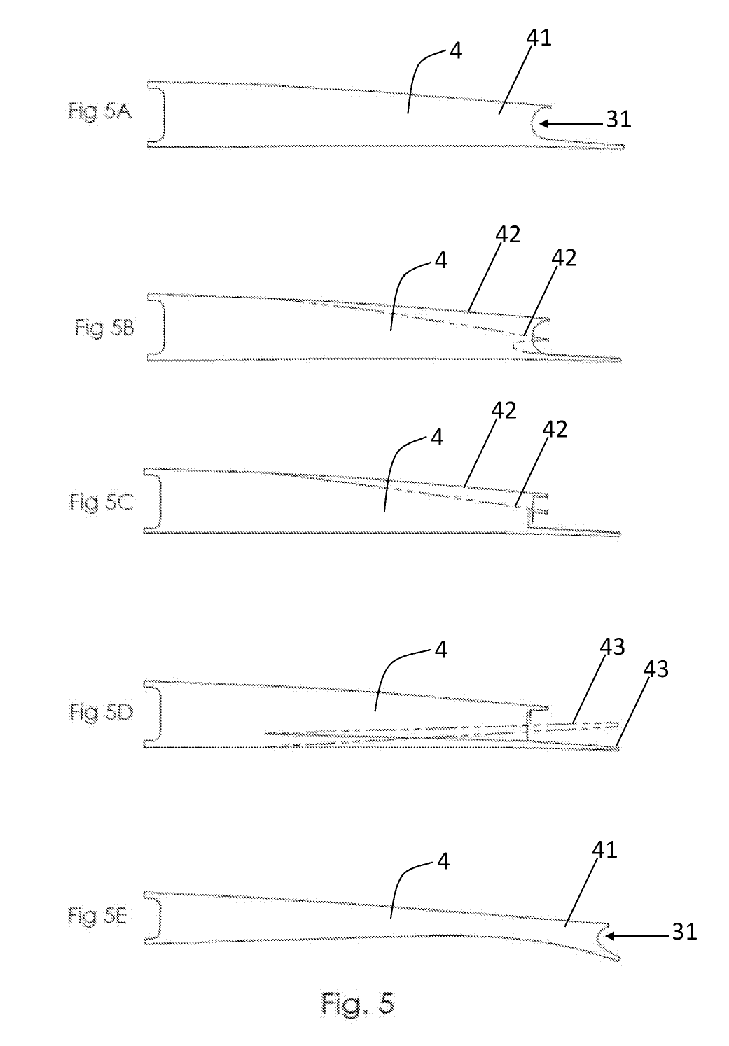

The cruise miniflap can be extended outwards up to 7% of the wing chord length (see FIG. 1C, wind chord length is distance between the trailing edge 3 and the point on the leading edge 10a where the chord intersects the leading edge). By that, a cavity 31 is formed in the trailing edge 3, i.e. in the rear edge 41 of the cruise miniflap with the greatest possible height H (see FIG. 1C) of 1% of the wing chord. This state of the cruise miniflap is used at the maximum take-off weight of the aircraft in the initial stage of the flight. The arrangements shown in FIG. 1B are used at the cruise stage when the weight of the aircraft has decreased as the fuel has been consumed. In this case, the cruise miniflap has extended outwards from the wing by 2-6% of the chord and the height of the cavity 31 is usually 0.5-0.7% of the chord. In the final stage of the flight, the cruise miniflap may be in the retracted state with the lowest aerodynamic drag, which is shown in FIG. 1A. At that, the cruise miniflap is entirely within the wing configuration and the height of the trailing edge is 0.1-0.3% of the wing chord. When the fixed-height cruise miniflap shown in FIG. 5A is used, its height in the arrangements depicted in FIGS. 1C and 1B does not change and is usually 0.5-0.7% of the wing chord. In the retracted state, the cavity is virtually non-existent because the miniflaps are deep within the wing and the height of the trailing edge is in the range of 0.1-0.3% of the wing chord.

During the cruise, the cruise miniflap extends outwards from the wing by 2-6% of the wing chord and the height of the cavity in the rear end of the cruise miniflap is within the range of 0.5-0.7% of the wing chord, but in the final stage of the flight it is entirely within the trailing edge flap configuration and the height of the edge is in the range of 0.1-0.3% of the wing chord. The profile of the cavity in the miniflap rear edge is curved inwards, whereas the edge of the lower side of the miniflap extends by 0.4-1.0% of the wing chord over the edge of the upper side. Alternatively, the profile of the cavity in the rear edge 41 of the cruise miniflap may be rectangular and the edge of the lower side of the miniflap extends by 0.5-2.0% of the wing chord over the edge of the upper side. In various embodiments, the upper surface of the cruise miniflap may be movable downwards or its lower surface may be movable upwards.

In alternative embodiments, the cruise miniflap may have rear sections with different profiles. In FIG. 5A, the profile of a fixed-height cruise miniflap (CMF) is shown, the shape of which in the retracted state is modified by the upper side of the trailing edge; FIG. 5B shows a cruise miniflap with an upper panel 42 of a changeable angle and height, which has practically no cavity in the trailing edge when in retracted state; FIG. 5C shows a variant of the cruise miniflap with a rectangular cavity and an upper controllable upper panel 42; FIG. 5D shows another variant of the cruise miniflap with a rectangular cavity and a controllable under panel 43; FIG. 5E shows a variant of the cruise miniflap of a shorter profile (the lower section projecting outward is shorter) where the lower surface of the miniflap has a downward curving surface and the lower rear edge 41 of the miniflap is shorter than that of the cruise miniflaps provided in FIGS. 5A-5D.

The invention can be described with following clauses:
1. A wing comprising a trailing edge cruise miniflap for improving the aerodynamic properties of an aircraft, wherein a main construction of the trailing edge flap (2) of the wing (1) comprises a trailing edge (3), a first spar and a rear spar (16, 17), a cruise miniflap (4) located between an upper panel of the trailing edge and a deflectable under panel and fixed to a control unit (7), wherein the control unit can be moved by means of a rear roller and a first roller (8, 9) along a guideway (10) attached to the main construction of the trailing edge flap, and the control unit (7) is through the rear roller coupled with a screw mechanism (12) which by means of a reduction gear (13) is coupled with a drive (11) intended for moving the cruise miniflap out of and in the trailing edge flap, and wherein the cruise miniflap has a cavity in its rear edge, the height of which is up to 1% of the width of the miniflap.
2. The wing comprising the cruise miniflap of the trailing edge flap as described in clause 1 for improving the aerodynamic properties of an aircraft, wherein during the cruise, the cruise miniflap extends outwards from the wing by 2-6% of the wing chord and the height of the cavity in the rear edge of the miniflap is in the range of 0.5-0.7% of the wing chord, and in the final stage of the flight the cruise miniflap is entirely within the trailing edge flap configuration and the height of the trailing edge is in the range of 0.1-0.3% of the chord.
3. The wing comprising the cruise miniflap of the trailing edge flap as described in clause 1 for improving the aerodynamic properties of an aircraft, wherein the profile of the cavity in the rear edge of the cruise miniflap is curved inward and the edge of the lower side of the cruise miniflap extends over the upper edge by 0.4-1.0% of the wing chord.
4. The wing comprising the cruise miniflap of the trailing edge flap as described in clause 1 for improving the aerodynamic properties of an aircraft, wherein the profile of the inward cavity in the rear edge of the cruise miniflap is rectangular and the edge of the lower side of the cruise miniflap extends over the upper edge by 0.5-2.0% of the wing chord.
5. The wing comprising the cruise miniflap of the trailing edge flap as described in any of the clauses above for improving the aerodynamic properties of an aircraft, wherein the upper surface of the cruise miniflap can be moved downwards.
6. The wing comprising the cruise miniflap of the trailing edge flap as described in nay of the clauses above for improving the aerodynamic properties of an aircraft, wherein the lower surface of the cruise miniflap can be moved upwards.
7. The wing comprising the cruise miniflap of the trailing edge flap as described in any of the clauses above for improving the aerodynamic properties of an aircraft, wherein the mechanism intended for moving the cruise miniflap comprising of a control unit to which the cruise miniflap is fixed, the first roller and the rear roller movable along the guideway that is attached to the main frame of the trailing edge flap, the actuating horn of the control unit to which the actuator screw mechanism is fixed and one end of which is, by means of articulations, connected with a reducing gear, and a drive for moving the cruise miniflap, which is connected with the reducing gear and fixed to the main construction of the trailing edge flap, is mounted within a trailing edge flap fairing located outside the trailing edge flap.

### REFERENCE SYMBOL LIST

1—Wing
10—Leading edge
2—Trailing edge flap
3—Trailing edge
31—Cavity in the rear edge of cruise miniflap
4—Cruise miniflap
41—Cruise miniflap rear edge
42—Cruise miniflap upper panel
43—Cruise miniflap under panel
5—Under panel of the trailing edge
6—Actuator for the under panel
7—Control unit
8—Rear roller
9—First roller
10a—Leading edge
10—Guideway
11—Electrical motor
12—Screw mechanism of the actuator
13—Reduction gear
14—Rear pivotal articulation
15—Actuating horn
16—First spar
17—Rear spar
18—Forward pivotal articulation
19—Fairing

What is claimed is:

1. An aircraft wing comprising a trailing edge flap, a first spar, a rear spar and a cruise miniflap;
the trailing edge flap comprising a trailing edge having an upper panel and a deflectable under panel;
the cruise miniflap being located between the upper panel and the deflectable under panel and being configured to be extended out of and retracted into the trailing edge flap by movement of a control unit along a guideway between the first spar and the rear spar;
wherein the cruise miniflap has a cavity in its rear edge, the cavity having a height up to 1% of width of the miniflap and wherein extending the miniflap out from the trailing edge flap provides a cavity onto the trailing edge.

2. The aircraft wing of claim 1, wherein the miniflap is configured to extend during a flight outwards from the trailing edge flap by 2-6% of the wing chord and the height of the cavity in the rear edge of the miniflap is in a range of 0.5-0.7% of the wing chord, and in a final stage of the flight the cruise miniflap is configured to be retracted entirely within the trailing edge flap and the height of the trailing edge is in the range of 0.1-0.3% of the chord.

3. The aircraft wing of claim 1, wherein a profile of the cavity in the rear edge of the cruise miniflap is curved inward and a lower side of the cavity formed by the lower panel of the miniflap extends beyond the upper side of the cavity formed by the upper panel of the miniflap by 0.4-1.0% of the wing chord.

4. The aircraft wing of claim 1, wherein a profile of the cavity in the rear edge of the cruise miniflap is rectangular and a lower side of the cavity formed by the lower panel of the miniflap extends beyond the upper side of the cavity formed by the upper panel of the miniflap by 0.5-2.0% of the wing chord.

5. The aircraft wing of claim 1, wherein the upper panel of the cruise miniflap can be moved downwards.

6. The aircraft wing of claim 1, wherein the lower panel of the cruise miniflap can be moved upwards.

7. The aircraft wing of claim 1, wherein mechanism for moving the cruise miniflap is mounted within a trailing edge flap fairing located outside the trailing edge flap.

8. A trailing edge cruise miniflap for improving aerodynamic properties of an aircraft, the miniflap being an ancillary aerodynamic surface on a trailing edge of a trailing edge flap of an aircraft wing;
the miniflap comprising an upper panel; a lower panel; and rear edge having a cavity; and
the miniflap being retractable into and extendable out from the trailing edge of the trailing edge flap.

9. The trailing edge cruise miniflap of claim 8, wherein miniflap is configured to extend outwards by 2-6% of chord length of the aircraft wing, and the cavity has a height in a range of 0.5-07% of chord length of the aircraft wing.

10. The trailing edge cruise miniflap of claim 9, wherein the height of the cavity is changeable by changing an angle of the upper panel or the lower panel.

11. The trailing edge cruise miniflap of claim 8, wherein the cavity at the rear edge of the miniflap has a curved surface and a lower edge of the cavity formed by the lower panel of the cruise miniflap extends beyond an upper edge of the cavity formed by the upper panel by 0.4-1.0% of length of the wing chord.

12. The trailing edge cruise miniflap of claim 8, wherein the cavity at the rear edge of the miniflap has an angular surface and a lower edge of the cavity formed by the lower panel of the cruise miniflap extends beyond a upper edge of the cavity formed by the upper panel edge by 0.5-2.0% of length of the wing chord.
